(19) United States
(12) Patent Application Publication
(10) Pub. No.: US 2005/0139540 A1
(43) Pub. Date: Jun. 30, 2005

(54) Static filtration media vessels

(75) Inventors: Bradley D. Mierau, Tampa, FL (US); Henry C. Reid, Safety Harbor, FL (US); Maryanne Reid, Clearwater, FL (US); John E. Nohren JR., Clearwater, FL (US); Gerald J. Larsen, Clearwater, FL (US)

Correspondence Address: NIXON & VANDERHYE, PC, 1100 N GLEBE ROAD, 8TH FLOOR, ARLINGTON, VA, 22201-4714, US

(73) Assignee: Innova Pure Water Inc., Clearwater, FL (US)

(21) Appl. No.: 10/853,709

(22) Filed: May 26, 2004

Related U.S. Application Data
(63) Continuation-in-part of application No. 09/963,636, filed on Sep. 27, 2001, now abandoned.
(60) Provisional application No. 60/239,249, filed on Oct. 11, 2000.

(51) Int. Cl. B01D 27/00

(52) U.S. Cl. 210/435; 210/504; 210/505

(57) ABSTRACT

A means of constructing water filtration and treatment products that fill rapidly without pressure, and freely dispense the treated water simply by the force of gravity. The means used to treat the water is by static filtration applying highly porous media which occupies all or a significant segment of the container of the product. The water is retained within the container in direct and constant contact with the treatment media thus providing residence time beyond the capability of other filtration technologies in similar size and types of containers, with numerous advantages over standard water filtration products.

### CROSS-REFERENCES TO RELATED APPLICATIONS

This application is a continuation-in-part of application Ser. No. 09/963,636, filed Sep. 27, 2001, the disclosure of which is incorporated herein by this reference. This application also claims the benefit of U.S. Provisional Application Ser. No. 60/239,249, which was filed Oct. 11, 2000, the disclosure of which is incorporated herein by this reference.

### BACKGROUND AND SUMMARY OF THE INVENTION

In co-pending application Ser. No. 09/506,575 filed Feb. 18, 2000 (Attorney Docket 13-90) and in co-pending provisional application Ser. No. 60/200,014 filed Apr. 27, 2000 (Attorney Docket 13-94), the disclosures of which are hereby incorporated by reference herein, various pitchers, static treatment media, and methods and equipment for making static filtration media.

The use of portable water filtration bottles, normally used outside of the home can be designed to treat water more slowly than a pitcher type product that frequently would like to be used as soon as possible after filling. Thus, the portable containers meant for use outside of the home utilize a modified static filtration media, which while providing the same exceptional contaminant removal capability, uses a less dense media providing more void area for water volume and requiring several minutes, typically up to five, and under ten minutes to fully treat the water. This is in contrast to the pitcher type products where faster treatment is highly desired, and perhaps a competitive necessity. However, the higher loft less dense static filtration media has application for pitchers that do not require the immediacy of treatment but rather a larger volume of water without increasing pitcher size. Further the use of vent tubes has the same virtues in pitcher configurations as in Sport Bottle or 1.5 liter bottle configurations. Each of the products are simple water containers of a different shape, with variations in utility, but embodying the identical design features and technology which constitute the herein described invention. Thus, according to the present invention a number of unique features and vessels are made possible through the utilization of the new high loft static filtration media and the applications thereof earlier described and incorporated by reference herein.

The products and procedures according to the present invention provide significantly enhanced portability, convenience and treatment capability to the consumers as an alternative to tap water providing better quality and taste at a fraction of the cost of bottled waters. The consumer for the past several years has had portable filter bottles available to them that contained either a small granular activated carbon filter or a relatively small radial flow carbon block filter. In either case a plastic “squeeze” bottle was required to force the water through the filter for drinking. Typically, such filters occupied between 10% and 20% of the containers volume. These filters impeded the water flow, which many bottle water users found unacceptable, as the water simple did not provide sufficient flow to be satisfactory. In actuality all the filters currently in use are dynamic (To pass through the media in a constant stream, this providing contact only for a very limited time), and residence time, time in contact, is the key to contaminant removal. Thus, flow rate vs. contaminant removal has been the trade off. The balance required has not proved totally satisfactory to the consumer. The inventors of the current invention are well aware of these facts, being the principal patent holders for that particular area in the state of the art; i.e., portable filter bottles employing radial flow carbon composite filters. The new filtration technology does not require a flexible bottle to “force” the water through the filtration media, thus a hard as well as a flexible, squeezable, bottle may be employed without preference.

The present invention, when applied to a portable Sport Type bottle as well as liter or greater sized bottles, that are taken from the house for a mired of purposes, are all well served by the disclosed invention. For the first time the consumer can have a portable water treatment product that would fill rapidly, as fast as the water would flow from a faucet and have exceptionally high rates of contaminant removal not otherwise obtainable. Contaminant removal is much greater, as well as more rapid, than any similar product. The contaminants removed include not only the chlorine and lead, but VOC's, volatile organic chemicals, which are cancer causing agents and others, not easily treatable with the standard dynamic filter technology. In addition the water is relatively free flowing from the bottle not requiring external pressure other than gravity.

To make this possible several new inventions were required. The most important being what is termed “high loft” static filtration media. This media is less than half as dense as the standard media disclosed in the prior patents and patent applications. As used in the prior inventions the media was of denser construction and was further compressed to idealize the void areas within the media, which the water would occupy. To meet the requirements and utility of this new class of product a different type of Static Filtration media is required, being at least half as dense as the preferred media in preceding applications. Typically, in the new applications the high loft media is not compressed to optimize the voids within which the water will accumulate and be treated. By so doing an extended residence time between 5 and 10 minutes vs. 1 to 3 minutes is desired. However, the high loft media provides substantially more volume for water, fills without resistance providing air is vented, and releases water without resistance, again with venting. It should be noted that venting might not be a necessity in all cases, but does enhance filling and pouring. To properly vent, a vent tube was developed to permit air to re-enter the container, at the base if the water flow was not to be impeded. The vent tube is further described in the detailed description of the drawings.

From the years of experience in the development, manufacture and sales of the more standard water filter bottles, previously described, it was found that a preponderance of users preferred to see how much water remained within the bottle, as well as to visually see the level of water when filling. Unfortunately, the static filtration media required is black, and consisting of a rather open non-woven material, it does not have esthetic appeal. Thus, it is desirable to encapsulate the media from the users view while, at the same time, permitting the user to visually see the level of treated water. This is accomplished by using an opaque inner housing containing the media and a clear outer housing with a space between the housings, which would contain treated water. Recognize that all the water contained within the bottle was fully treated after having been in contact with the media for 5 to 10 minutes. Any water passing directly through the media, not retained for static filtration, would be treated somewhat comparably to the current standard dynamic filters available. While the use of the double containers provides an elegant solution, it does add cost. Thus, all the functional advantages of the previously described product may also be contained within an opaque bottle that typically would be colored attractively. What the user gives up is the ability to see the water level, at a savings in cost. It should be noted that the clear outer housing is most desirable in bottles of from one to three liters rather than in a Sport type Bottle.

The identical features and technology representing the disclosed invention is embodied within the pitcher designs (which are simply another container format). As shown in the drawing represented by FIG. 6; inner and outer housings are employed for the purpose of removing the static filtration media from view while concurrently providing a relatively narrow space between the inner and outer housing. The space is just wide enough to allow the level of water in the annulus or space thus formed to be at the same level as within the media. Thus, a visual reference is created by which the level of water is immediately ascertained, as in the more portable containers. To increase the volume of water within the container a new high loft, static filtration media is used with the trade off being an extended 5-10 minute total contact time required for high levels of treatment. The new high loft media is less dense by approximately 50%-75%, The vent tube has the same utility, and also a somewhat reverse function from the smaller portable bottles or containers dependent upon the pitcher configuration. In the pitcher completely filed with the static filtration media the vent tube would normally vent the air during a rapid fill directly into the media with the pitcher top removed. Similarly, when water was being poured from the pitcher, water within the vent tube would immediately vacate the tube for the open chamber above the tube allowing a rapid pour without the requirement for the water to bubble out to allow air to enter the area vacated by the drawn water. The tilt of the tube to the rear facilitates this function. It is also foreseen where a static, multi purpose media be used made up of two or more layers of media each containing a different coating; one carbon, the second an ion exchange resin, KDF, zeolite, or base granular bed, etc. In such instance the vent tube would become a fill tube introducing the water at the bottom of the media that would allow the air within the media to escape with ease while concurrently forcing all the water to completely traverse the entire bed assuring maximum contaminant removal.

While the second Pitcher design as shown in FIG. 7 appears quite different, the same inventions are embodied; namely the use of two independent housings; the inner housing being partitioned as a raw water reservoir and a static filtration water treatment area. In this configuration the vent tube functions solely as a fill tube allowing the integration of a pre-filtration element such as turbidity filter, a hollow fiber membrane, or other low porosity or sub-micron filter for the removal of biological contamination. Thus the water flows initially from the raw water reservoir, through the pre-filter typically threaded into the housing with an “O” ring seal. The pre-filter discharging the then so treated water into a small reservoir to which the fill tube is attached. The fill tube introduces the water at the point within the static filtration bed furthest from the exit port, thus requiring the water to transit the entire bed prior to discharge. A small air relief hole is at the top rear of the Static Filtration bed housing, essentially directly above the base of the fill tube. When water is poured from the container a direct unencumbered air passage is created between the walls of the inner and outer housings. One obvious question is the reason for the reduced Static Filtration bed volume and how it can function. The initial appearance would seem to dictate a dynamic mode of operation that would be less effective. The design is based upon anticipated duty cycle. By this is meant the quantity of water that would normally be anticipated to be poured within a 5-10 minute period. This design would typically accommodate two glasses every 5-10 minutes, with shorter residence times still delivering water with reasonably high levels of containment removal. In other words the area occupied by the Static Filtration Media would be such as to retain and pour 16 ounces. This can be changed to practically any number by adjusting the bed size and container. By using the same high-loft media as described, all products will contain a larger water volume within the given bed area. The same rational is followed for this product incorporating the same invention as the other configurations disclosed for purposes of clarity and a broad understanding of the invention and significance thereof.

The Static liquid treatment media disposed within the inner body functions differently than the typical hollow block carbon dynamic filter, or granular activated carbon media, normally used. The media consists of fine non-woven polyester fibers that are specially treated to permit bonding upon their entire surface a layer of activated carbon, zeolite, ion exchange resins, or other treatment media in powder form in such a manner as to retain the media to the fibers without blinding the active sites. Functionally, the water to be, or being treated is always in contact with the media while in the bottle or container. The contaminants within the water adjacent to the media coated fibers are adsorbed by the media. As there are voids within which the water resides within the coated fiber matrix, as the contaminants are removed from the water in contact with the media coated fibers, the remaining contaminants seeking equilibrium within the water, migrate into the area adjacent to the fibers and are in turn removed. Thus, the process of contaminant dispersion caused by the search for equilibrium rapidly removes most all of the contaminants form the contained water. No other process is as effective, operates in this manner, nor provides the extended residence time that static filtration does. In a portable bottle the movement of the water within the bottle further enhances dispersion and contact with the treatment fibers.

The bottle or container typically contains a vent tube, centrally located for convenience, extending from an area just above the top of the media, or pre-filter to the base of, or just below, the media contained within the container. A provision for a small void between the base of the media and the bottom of the container may be left to facilitate the transfer of air into or out of the media filled container. Preferably the vent tube has a larger open cross sectional area at the top or neck end. For example, this may be provided by constructing the vent tube so that it has a flare from a point approximately ⅓ the length of the tube from top open end providing a slight venturi effect. Also, the top end of the vent tube located in the neck of the container preferably has a hood to minimize or prevent water from entering the vent tube while the container is being filled. The hood may be an attached component of the tube or connected to an outer supporting element by a plurality of substantially radial support arms, and the outer supporting element operatively connected to the container adjacent the neck or open end thereof. A second component of the supporting arms is at the point of contact with the bottle where a section in a doughnut configuration forms a shield protecting the open annulus or space between the inner and outer housings from filling with untreated water during the fill operation.

In addition to the static filtration media, the container may further incorporate a conventional screen or non-woven fiber particulate filter between the static treatment media at the entry of the liquid passageway. While functional for the removal of larger particulate matter, on entry, the other purpose is one of appearance, cosmetically and esthetically. A secondary particulate filter may be positioned as a post filter to eliminate the possibility of any carbon fines that may come loose from entering the discharged product water.

In a preferred embodiment the static filtration media comprises a non-woven mat of a material capable of meeting 21 CFR 177.2260, having a weight of between about 7 oz/sq. yd., and a coating comprising about 80%-150% of the weight of the mat, and including, by weight, or about 85% activated carbon, about 10-20% binder, and about 0-20% zeolite. KDF which is an amalgamation of zinc and copper may also be added for control of biological growth, with a loading of approximately 8%-12%. The mat may be of polyester non-woven material and may be in roll or pleated form (such as disclosed in EP 0402661 or U.S. Pat. No. 5,674,391, which have been incorporated by reference herein). The fibers may be polyester, and the mat may substantially fill either all or part of the inner body and have a porosity of at least 90%, prior to any compression which may either occur or be designed in.

The closure may comprise a wide variety of conventional structures, such as a cap with a conventional manual valve (such as shown in U.S. Pat. No. 5,609,759), a bite type valve or baby bottle style nipple or the closure may comprise a substantially solid cap, with a screw-on arrangement.

According to another aspect of the present invention a static filtration media is provided comprising a composite structure of activated carbon, ceramic ion-exchangers of either the class of zeolites, or amorphous gels comprised of sodium salts of aluminum silicates or titanium silicates, and a polyester substrate carrier in one of sponge or fiber form, preferably without being compressed to form a treatment zone so that contaminate molecules suspended in water contained in the treatment zone are within about 1-5 mm of the carbon or zeolite coated matrix. The media may be contained in (and substantially fill the operative portions of) a filter housing which holds between approximately 8 and 48 ounces of water, the treatment media removing at least about 70% of chlorine and at least about 90% of lead within about 5-10 minutes (preferably about 5) minutes of filling of the filter housing.

The philosophy behind, and scientific description of, a matrix according to the invention will now be set forth.

The extra particle extra fiber porosity of the treatment matrix may be closely controlled to optimize the functions of (1) Filling or replenishing, (2) Time in contact required to achieve contaminant results and, (3) Rate of pouring, or flow of treated water from the treatment media. Functions (1) and (3) are most easily achieved with a more open, less restrictive filter density. Function (2), contact time required is reduced as the density is increased.

The BET surface area (Journal of the American Chemical Society, vol. 60, p309, 1938) of a particular adsorbent is often used to reflect the number of binding sites available for contaminant removal per unit mass, and the ratio of pore volume to this surface area as an indicator of adsorption preferences based on molecular size of the contaminant. The porosity (pore volume per unit mass) of an adsorbent has also been used to provide an indication of adsorptive capacity. However, fluid contained within the pore structure of the adsorbent media is not generally accessible for removal from the filter, as capillary forces tend to hold it in place. Thus the overall porosity of the medium is not a useful descriptor of the treatment capacity of an adsorbent bed used in static treatment.

The only fluid (in particular water) which is available for use from any filtration device is that which is contained in the extra-particular or ‘bulk’ volume surrounding the adsorbent. In static treatment, this bulk volume must be sufficient to deliver a useful amount of fluid from the filter when drained, yet the distance between adsorbent particles must be small enough for the bulk fluid to approach equilibrium within a practical time.

A useful term to describe a filter medium, which can be operated in a static manner, is the ratio of “readily deliverable fluid volume” (RDV) to total bed volume (BV). Readily deliverable fluid volume is defined here as the volume of fluid, which will quickly drain from a decanted filter bed without the application of any external force (other than gravity). The word “quickly” in the previous definition refers to the time prior to the cessation of streaming flow. High Loft Static filters typically exhibit RDV/BV ratios from 85 to 92 percent.

Traditional filtration devices cannot be operated effectively in a static manner, because the extra-particular bulk volume in a packed bed is very small relative to the bed volume. The RDV/BV ratio of a granular activated carbon bed packed with 12×30-mesh carbon is typically 9 percent for a cylindrical bed around 8.5 inches in depth and 4.5 inches in diameter, as measured from cessation of streaming flow. The argument cannot be made that a packed bed overlaid with a column of fluid constitutes static treatment, as the mean distance between a fluid molecule and an adsorptive site is too large to allow for treatment within a reasonable amount of time. In addition, in such a system the torturous nature of the fluid path between the particles of the packed bed would hinder diffusion to the point of making the majority of the bed inaccessible to adsorption.

It is a primary object of the present invention to provide for enhanced effective filtration of water to remove chlorine, lead, and other contaminants there from, in an efficient and cost effective manner. This and other objects of the invention will become clear from an inspection of the detailed description of the invention and from the appended claims.

### BRIEF DESCRIPTION OF THE DRAWINGS

FIG. 1 is a side schematic cross-sectional view of an exemplary container according to the present invention;

FIG. 2 is a cross-sectional view taken along lines 2-2 of FIG. 1;

FIG. 3 is a cross-sectional view of the vessel of FIG. 1 taken at the top of the bottom of the vessel;

FIG. 4 is a schematic perspective view of an exemplary piece of filtration media mat representing the static filtration non-woven base material according to the present invention;

FIG. 5 is a view like that of FIG. 1 of another embodiment of a vessel according to the present invention embodying a single housing and

FIGS. 6 and 7 are views like that of FIG. 1 only of still other modifications of vessels pursuant to the present invention incorporating inner and outer housings, static filtration media, and a vent or fill tube comprising the principal aspects of the invention.

### DETAILED DESCRIPTION OF THE DRAWINGS

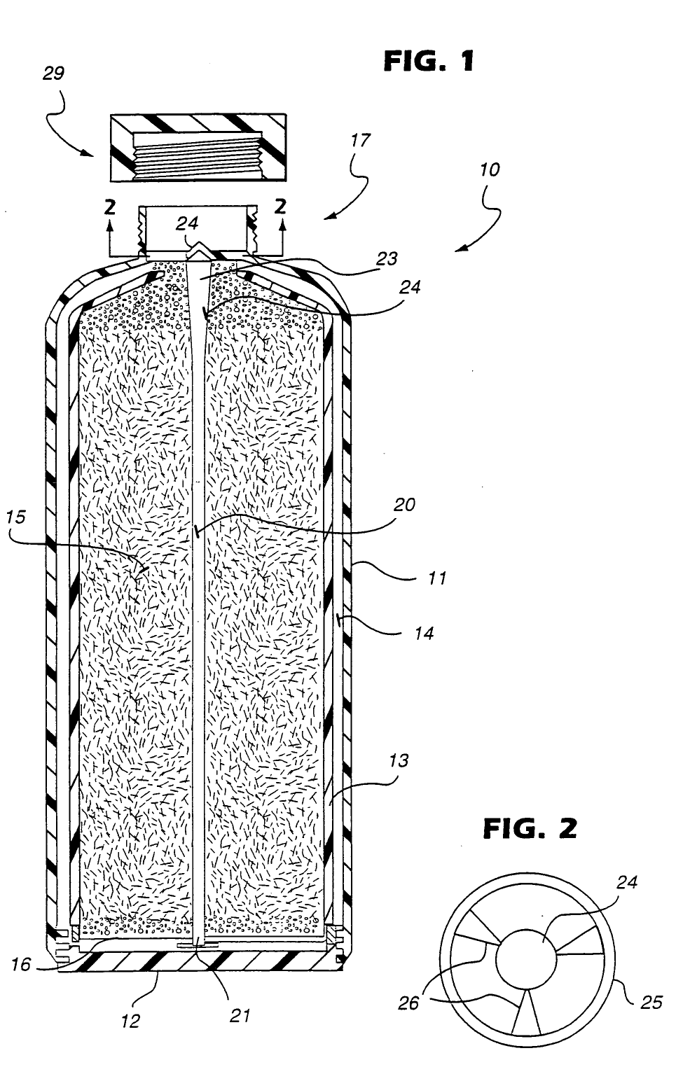

FIG. 1 generally illustrates a vessel 10 according to the present invention capable of providing an exceptionally high degree of water treatment or filtration by means of static filtration, requiring only gravitational forces. The vessel or container uniquely consists of an inner and outer housing, the inner housing to contain the filtration and treatment media and is opaque for esthetic reasons. The outer housing is clear and is sufficiently larger in diameter to create a void area between the housings which functions as a treated water reservoir, the real purpose of which is to allow the user to visually determine the amount of water remaining within the total container. It is critical to recognize that the treatment media is used in a static filtration mode, while filling the void volume of the inner housing, in fact represents only between ten and twenty percent of the actual volume present. The water being at the same level in the inner housing as within the annulus formed by the void between the inner and outer housings. The vessel 10, includes a neck or open end 17, which is at a first end of the bodies 11,13, opposite the substantially closed bottom 12, through which water enters the inner filter body 13. at fill port 1. Unique features, which permit this filtration device to function at very high performance levels, include the construction features at the water entry or fill point 1. These are the open top end 3, of the inner housing 13 that is larger in diameter than the water entry point 1, and is also protected from untreated water from entering the reservoir annulus 14 during filling by means of a baffle 2, which extends over the treated water exit from 14 at 4. The static filtration media 15, is highly porous providing very little resistance to filling. Treated water enters the annulus reservoir 14 by means of open ports 16, permitting the volume of water to be equal with the volume remaining within the filtration media and housing 13. However, it has been found that both filling and pouring is enhanced by the inclusion of an air relief tube 20. A shroud 24 is positioned over the top of the relief tube that precludes water from entering during filling but permits the escape or entry of air, as required.

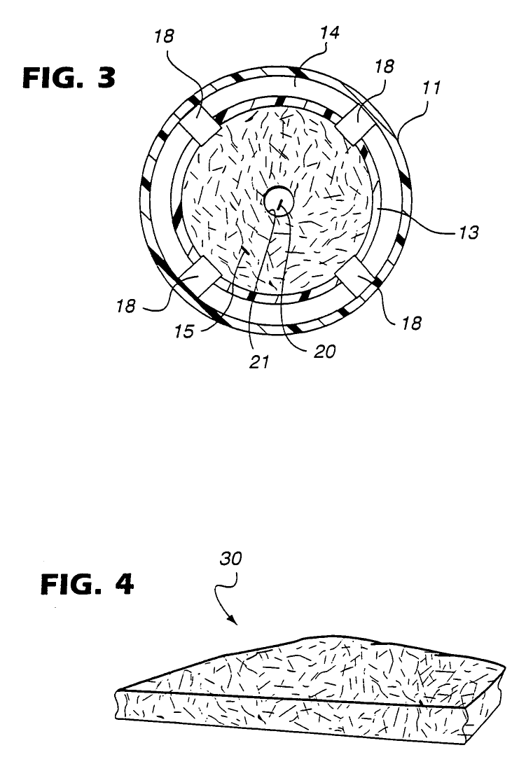

In the embodiment illustrated in FIGS. 1 through 3, the vessel 10 has an outer body having a sidewall 11 of substantially transparent or translucent material, and a substantially closed bottom 12. The sidewall may be continuous (e.g. a cylindrical side wall) or may have a number of flat surfaces, e.g. be polygonal in cross section, or have a wide variety of other shapes. The vessel 10 further comprises an inner body 13 of substantially opaque material, the inner body spaced from the outer body to define a volume 14 there between. In the preferred embodiment illustrated in the drawings, as seen particularly from FIGS. 1 and 3, the bodies 11, 13 are substantially concentric, and the volume 14 is substantially cylindrical and annular, and the bodies 11, 13 are substantially circular in cross-section, and the inner body has an outer diameter (or cross-sectional area where not circular) of about 2-5% less than the inner diameter (or cross-sectional area if not circular) of the outer body 11. In the preferred embodiment, substantially the entire outer body 11 (e.g. at least about 80% thereof) is transparent, such as of glass, or hard or flexible (squeezable) plastic, and the inner body 13 may be made of any suitable material, and is preferably opaque.

The design is such to preclude untreated water from entering the annulus 14 formed between the inner and outer housing when filling. At the neck or open end 17 a secondary particulate filter of conventional construction is provided, and such a filter may also or alternatively be provided at the bottom of the interior of the inner body 13, also whether or not a secondary particulate filter is provided at the bottom of the interior of the inner body 13, a plurality of support elements 18 (see FIG. 3 in particular) are preferably provided for supporting the inner body or shell 13 within the outer body/shell 11 to provide radial alignment relative to housing 11 This can also be accomplished by adapting the shapes of the inner and outer bodies to nest together at two points, typically at the top and bottom.

Also, the vessel 10 preferably comprises a vent tube 20 that is open at the base end 21 adjacent the bottom 12 as illustrated in FIG. 1. The vent tube 20 has a second open end 23 adjacent the neck or open end 1 of the vessel 10. In the preferred embodiment illustrated in FIG. 1, the portion 24 of the vent tube 20 adjacent the second end 23 thereof (e.g. the top approximately ⅓ of the vent tube 20 as illustrated in FIG. 1) is flared so that it has a larger cross-sectional area at the second end 23 than does the majority of the vent tube 20, and particularly a greater cross-sectional area than at the first end 21 enhancing the air flow. When the vent tube 20 is provided, there is a non-interrupted stream of water that is delivered out of the neck or open end 17 during pouring or other discharge from the vessel 10 without the undesirable intermittent bubbling flow associated with a “glug, glug” sound when venting is inadequate, and flow is retarded. The outer flare adjacent the second end 23 enhances the venting function.

In this instance the hood and tube is positioned and supported by structure 25 (see FIG. 2) with radially extending arms 26 with the hood section just above the second open end 23. The annular support 25 can be adhesively secured, ultrasonically welded, (screw threaded) or in any other conventional manner affixed to the inner surface of the neck or open end 17 so as to properly position the vent tube and hood 24 to deflect liquid from the vent tube 20 when filling and releasing the trapped air facilitating filling and conversely allowing air to enter the container eliminating the vacuum, or differential pressure effect during discharge of liquid from the container 10.

The vessel 10 also preferably comprises a closure, such as the solid screw-on cap 29 illustrated in FIG. 1 for closing the top of the neck or open end 17. Alternatively the closure 29 could connect to the neck or open end 17 by a mechanism other than screw threads, and the closure 29 need not be solid but may include a manual valve (such as a conventional bicycle bottle pull-push valve), or other conventional construction.

While in the embodiment of FIG. 1 the vessel 10 is illustrated so that the bottom 12 of the outer body having a side wall 11 is integral with the side wall 11, the vessel can be constructed so that the bottom 12 is removable (e.g. screws off) as long as a tight seal is provided when the bottom 12 is attached to the side wall 11. The removable base can be incorporated with a single or two compartment bottle and is typically of the diameter of the bottle at its widest base dimension. The large base facilitates the ease of assembly of the filtration components and may also be used as a centering means when an inner housing is used.

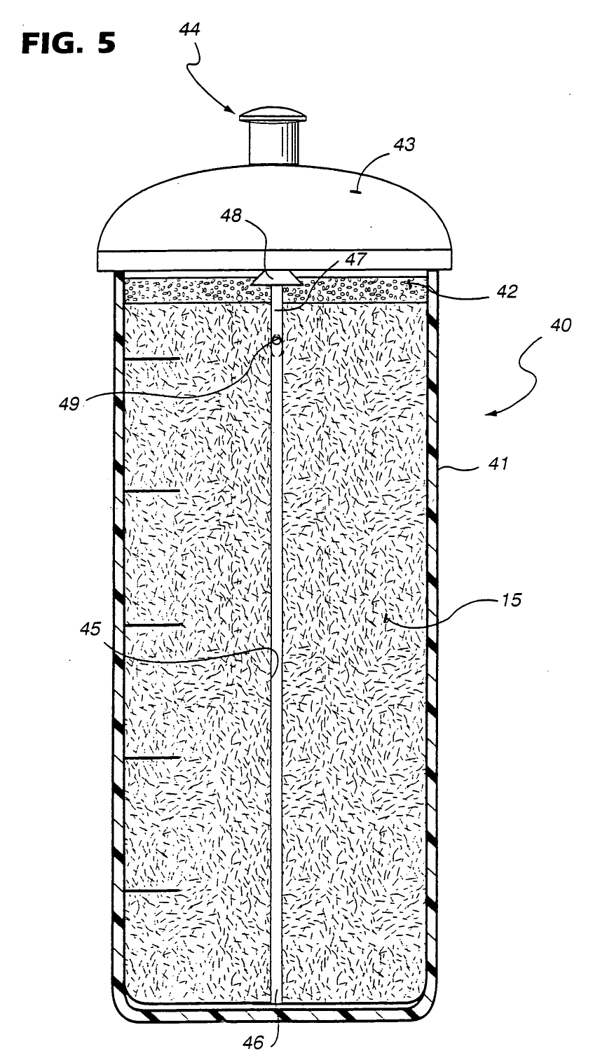

FIGS. 5 through 7 illustrate other embodiments of vessels that may be utilized with the static filtration media 15 according to the present invention in an effective manner.

The embodiment of FIG. 5 includes a vessel 40 which has a resilient plastic body bottle 41 as one of the main components thereof, the resilient plastic body 41 being substantially filled with the filtration media 15. A conventional fine particle filter 42 may be provided at the top of the plastic body 41 which allows water to pass into and out thereof. The bottle 41 has a removable cap 43, which preferably comprises a screw cap having a conventional pull-push valve 44 at the top thereof for dispensing liquid from the bottle 41.

It is desirable to have an air relief tube 45 extending substantially through to the center of the bottom end 46 of the tube 45 is preferably open, as is the top end 47, although it is preferably covered with a water deflector or snorkel 48 to prevent water from flowing directly into the tube 45 and thus occluding it when the vessel 40 is being filled (with the cap 43 removed). The water deflector 48 is attached to the open top 47 of the tube 45 by a plurality of support arms so that water moving downwardly is deflected by the element 48, but air can easily pass under the element 48 into the open end 47 of the tube 45. The tube may also be secured by simple rolling the media about the tube thus both centralizing while providing support of the tube.

If desired, an optional conventional flow restricting valve 49 may be provided in the tube 46 which can preclude water from exiting the bottle through the tube while allowing the passage of air either during filling or the venting cycle.

When utilizing the configuration of FIG. 5, the cap 43 is removed and water flows downwardly into the bottle 41 in contact with the media 15. When the cap 43 is screwed back on and the valve 44 opened, the bottle 41 may be squeezed so as to expel water through the particulate filter 42 and through the open valve 44. With the high loft media the water essentially flows freely, requiring a minimum to no squeezing of the bottle unless a heavy continuous stream of water is desired. The static filtration media 15 has sufficient flexibility so that the media recovers its shape and uniformity following each duty cycle. The air relief tube 45 allows the air to vent from the media 15 when the bottle 41 is being filled, the air moving up through the tube 45 to pass underneath the water deflector 48 and then out of the open top of the bottle 41. If a vent tube 41 is not employed, air evacuation may be improved by repeatedly flexed the bottle 41 during filling to force trapped air out of the lower portions of the media 15.

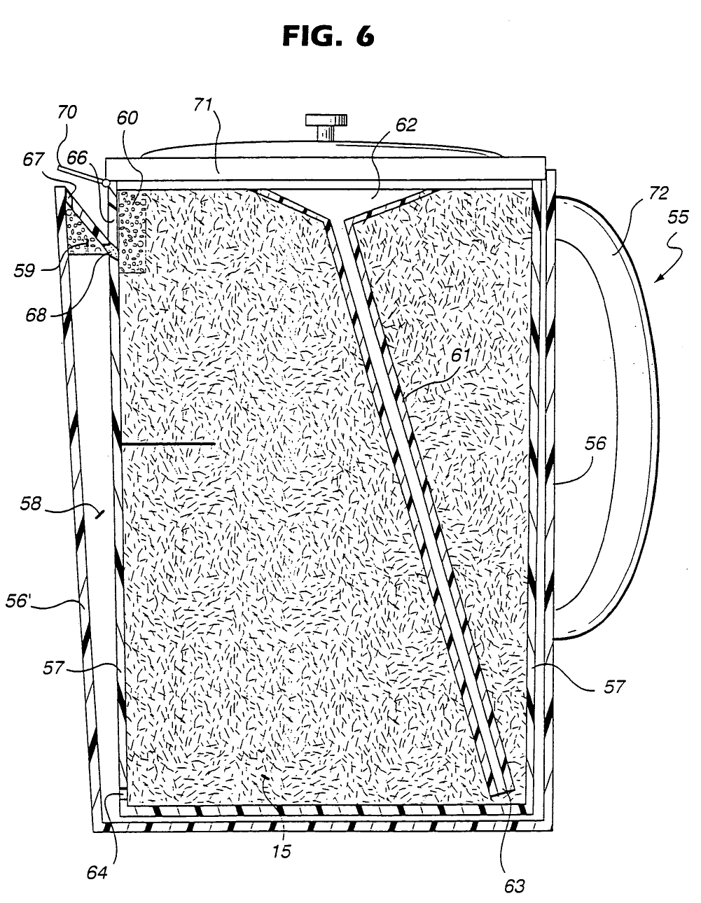

In the embodiment illustrated in FIG. 6, a vessel 55 is provided having an outer body 56 and an inner body 57, with a spout portion 56′ of the outer body 56 preferably of transparent material so as to provide a fill level indicator and to also illustrate the clarity of the water in the volume 58 between the inner body 57 and the spout 56′. In this embodiment conventional particle filters 59 and 60 may be placed as desired. As in the other embodiments the static filtration media 15 is disposed in the interior body 57 and substantially fills it, although it is desirable to include a fill or air relief tube 61 having an upper conical/funnel shaped fill port 62 to which liquid flows when the vessel 55 is being filled, being discharged out the open bottom 63 of the fill tube 61 to move into the media 15. The opposite function is provided if the water is poured directly to the media upon filling, thus rendering the tube a vent tube. Regardless, this same function occurs upon pouring. One or a plurality of ports 64 may be provided in the vessel body 57 to allow treated liquid to flow into the volume 58 to provide the functions indicated above. Liquid can then be poured out of the vessel 55 through a relatively large opening 66 adjacent to the particle filter in the top portion of the inner body 57 adjacent the spout 56′, and through the opening 67 in the divider 68 between the volume 58 and the opening 66, the opening 67 adjacent the particle filter 59. A hinged exit flap 70 may be provided attached to the removable top 71 so that when the user grasps the handle 72 of the vessel 55 and tilts it, the flap 70 will pivot open while water is dispensed through the openings 66 and 67 out of the vessel 55.

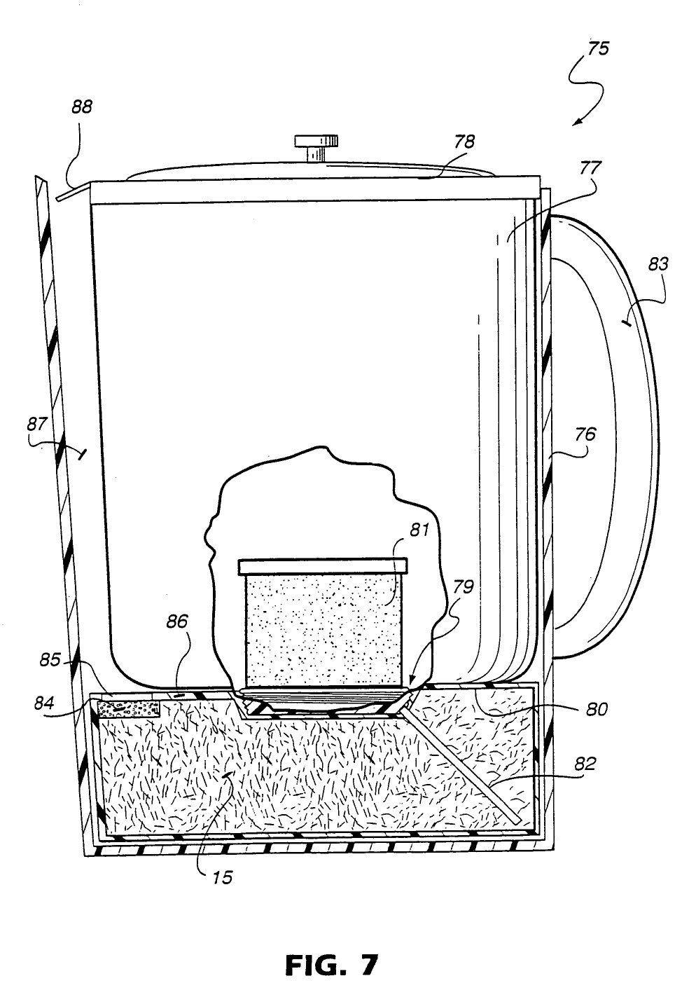

In the embodiment of FIG. 7, a vessel 75 is provided having a static filtration media 15 defined in a bed that only takes up a partial portion of the interior volume of the vessel 75, preferably adjacent the bottom thereof as illustrated in FIG. 7. In this embodiment the outer body 76 has an independent raw water reservoir housing 77 that can be removed from the outer housing 76. The cover 78 is removed and water poured therein to fill the raw water reservoir. The raw water reservoir 77 has an opening 79 in the bottom 80 thereof, and a protozoa or bacteria filter 81 is mounted in the opening 79. For example, filter 81 can be threaded into the opening 79, and an O-ring or like seal may be provided. Raw water must then pass through the conventional filter 81 and flows through the water entry tube 82 into the static filtration media 15. There, lead and chlorine and the like are removed.

When a user grasps the handle 83 of the vessel 75 and tilts it, treated liquid flows through the static filtration media 15, preferably through the final particle filter 84, through the opening 85 in the solid wall 86 of the canister containing the filtration media 15, and then into the pour reservoir 87, moving past the hinged flap 88 to be dispensed. As the reservoir 77 is preferably removable from the vessel 75, it is maintained in place (by any suitable locating or latching mechanisms, conventional per se) within the vessel 75 until it is desired to remove it. When removed, the internal filter housing 80 may be easily removed.

It will thus be seen that according to the present invention a very simple yet effective static filtration media, and various vessels optimally using the static filtration media, have been provided. While the invention has been herein shown and described in what is presently conceived to be the most practical and preferred embodiment thereof it will be apparent to those of ordinary skill in the art that many modifications may be made thereof within the scope of the invention, which scope is to be accorded the broadest interpretation of the appended claims so as to encompass all equivalent structures and devices and methods. Also, each of the numerical ranges set forth above specifically includes all narrower ranges within a broad range.

1. A water treatment container utilizing a high loft low-density non woven substrate of-polyester fibers - - - coated with from 50 percent to 130 percent of weight to substrate with any one or more of a water treatment media such as activated carbon, zeolite, KDF or other media, singularly or in combination, and used primarily in a static filtration mode capable of rapidly filling and rapidly dispensing water treated to a high level of contaminant removal with an allowed residence time of 3-10 minutes.

2. A water treatment container as described in claim 1 the void volume of which is essentially filled with the high loft low-density media. Which at one inch in thickness has a weight of typically 7 oz/sq.yd. and sufficient structural integrity to maintain its size and shape with and without the presence of water while maintaining a “spring-back” strength or capability to recover fully from any deformation caused by a normal compression that may occur should the container be flexible and subject to being squeezed and deformed by hand pressure, of typically a polyester thread diameter of 15, 25, or 40 denier which is enhanced by the addition of a flexible binder securing the media to the polyester fiber substrate which may be used in the form of a cylindrical roll, pleated, or consist of a bed made up of a number of individual pieces in cubic or other geometric shape, which made be distorted or compressed to conform with the container.

3. A water treatment container as described in claim 1 which contains high loft low density media of from ½ inch to 2″ in thickness with a readily deliverable fluid volume to bed volume of approximately 85-92 percent (RDV/BV).

4. A water treatment container as described in claim 1 which may consist of an inner and outer container, the outer container typically clear and the inner container opaque and containing the high loft low density media; the diameter difference between containers forming an annulus or space into which treated water flows and visually indicates the level of water within the inner and outer container, yet designed to preclude the entry of untreated water into the annulus.

5. Water containers as described in claim 1 which may be flexible or ridged and of any practical and convenient shape suitable to their specific purpose including cylindrical, radiused rectangle, obround, flat iron or such shape as may be designed to fit the purpose.

6. A water treatment container as described in claim 1 utilizing a high loft low-density non woven substrate which also incorporates a vent tube typically extending above the level of the media to the base of the media to permit entrapped air to escape during filling as well as air to enter replacing the water during the pour cycle; such vent tube is shielded by an overhanging cover to prevent untreated water from entering the tube. The tube may be flared starting approximately ⅓^{rd} of the way from the top to the top.

7. A water treatment container utilizing a high loft low-density non woven substrate particularly in a pitcher type configuration and normally consisting of an outer housing containing the water treatment media, a water accumulating area may be between the two housings through 360°, or simply at the front pouring area of the pitcher, permitting the user to visually ascertain the amount of water remaining within the pitcher.

8. The pitcher in particular, but also the Sport type bottle may incorporate several different medias including fine granular activated carbon, zeolite, ion exchange resins, and zeolite, all or one of which may be combined upon a single substrate but also differentiated substrates each with a specific and complementary function coated with the media(s) of choice; such as arsenic removal compounds, and medias specific to the removal of small particulate matter, turbidity. Using an upper and lower treated media, or simply a retaining screen granular activated carbon, ion exchange or other granular media beds may be combined with the low density material.

9-14. (canceled)
